(19) United States
(12) Patent Application Publication
(10) Pub. No.: US 2008/0059648 A1
(43) Pub. Date: Mar. 6, 2008

(54) Dynamically Configurable Processing System

(75) Inventor: George Edwin Manges, Canyon Country, CA (US)

Correspondence Address: COURTNEY STANIFORD & GREGORY LLP, P.O. BOX 9686, SAN JOSE, CA, 95157, US

(73) Assignee: Freedom Broadcast Network, LLC, Santa Clarita, CA (US)

(21) Appl. No.: 11/845,725

(22) Filed: Aug. 27, 2007

Related U.S. Application Data
(60) Provisional application No. 60/842,073, filed on Sep. 1, 2006.

(51) Int. Cl. G06F 15/16

(52) U.S. Cl. 709/231

(57) ABSTRACT

Dynamically configurable processing systems and methods are described herein. The dynamically configurable systems and methods receive at a device a data stream that includes a processing component and data. The processing component is detected and used to configure a subsystem of the device. Data of the data stream is processed by the configured subsystem.

### RELATED APPLICATION

This application claims the benefit of U.S. Patent Application No. 60/842,073, filed Sep. 1, 2006.

### TECHNICAL FIELD

The disclosure herein relates generally to processing systems. In particular, this disclosure relates to dynamically configurable streaming data systems and methods.

### BACKGROUND

Technologies for streaming audio/video (A/V) signals via a packet network have historically faced a number of obstacles. These obstacles include difficulty in creating a compression technology which provides a compression rate that allows large, high quality images to be transferred over network connections having limited bandwidth. Further obstacles in conventional streaming technologies include difficulties associated with efficiently updating existing Video Player Software (VPS) on a user's Host Display Device (HDD) as more efficient compression technologies subsequently emerge. Conventional streaming technologies also face challenges in dealing with issues related to increased processor requirements in HDDs as compression algorithms become more complicated. As the compression efficiency increases so that larger images can be transmitted, the load on the processors in the HDDs increases and more and more expensive display devices are thus required to display streaming content like A/V content.

Conventional HDDs include VPS that consist of one or more software applications or programs that function to decompress and decode or decrypt a data stream received from a central server into an A/V signal capable of being displayed on the HDD. The received data stream is typically a compressed and encoded video stream received from a central server. The VPS also performs the associated functions required to manage the data path of the data stream as it is routed through components of the HDD, functions that include input/output (IO), frame buffering, packet scheduling, memory management, and video output, to name a few.

Conventional HDDs include numerous configurations for hosting the VPS. One HDD configuration stores the VPS in a memory device (e.g. hard drive, flash memory, etc.) of the HDD. The VPS is installed upon the hard drive or into flash memory of the HDD, as the VPS must be initially installed on the HDD prior to displaying compressed and encoded data streams. The HDD is required to have sufficient computing power in the form of central processor (e.g. central processor unit (CPU), microprocessor, etc.) capability and memory to successfully execute the VPS and decompress, decrypt, and display the encoded A/V content of the data stream. The VPS must be also updated by the user when the software component distributor of the VPS updates or changes the any algorithm or component of the VPS.

Conventional HDDs also include VPS hosting configurations that embed the VPS in a computer chip, chipset, or other IC device of the HDD. For example, the VPS can be embedded in a microchip located in the HDD. The compressed and encoded data stream, when received by the HDD, is decompressed and decoded completely within the microchip. This VPS microchip configuration allows for the use of a less powerful main processor within the HDD. However, a limitation of this configuration is that when the VPS software component distributor changes any components of the VPS, the VPS hosted in the microchip is rendered obsolete and requires physical replacement of the microchip.

Conventional HDDs can include configurations in which the VPS is contained within the data stream delivered to the HDD. Upon receipt by the HDD, the VPS is downloaded from the data stream and stored in memory on the HDD. The HDD subsequently executes the stored VPS to process the compressed and encoded data stream. While this VPS download configuration solves the problem occurring when there is a need to update the VPS due to a change in the compression algorithm, the problem remains with increased processor demands on the HDD. The VPS download configuration thus requires the HDD to have sufficient computing power in the form of central processor (e.g. central processor unit (CPU), microprocessor, etc.) capability and memory to successfully execute the VPS, decompress, decode and decrypt the compressed and encoded data stream, and display the decompressed and decoded A/V content

An additional deficiency encountered in the conventional HDD systems is that each VPS is typically capable of decompressing and decoding only a single compression and/or encoding algorithm. Therefore, if the HDD is configured to decompress and decode data streams created with different compression and/or encoding algorithms, a different VPS is required for each compression and/or encoding algorithm. Consequently, there is a need for a dynamically configurable system for processing streaming data.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a processing system including a dynamically configurable streaming system (DCSS), under an embodiment.

FIG. 2 is a flow diagram of dynamically configurable processing, under an embodiment.

FIG. 3 is a block diagram of a processing system including a DCSS, under an embodiment.

FIG. 4 is a flow diagram of dynamically configurable processing, under an embodiment.

FIG. 5 is a block diagram of an example of an integrated data stream, under an embodiment.

FIG. 6 is a block diagram of an example of an integrated data stream, under an alternative embodiment.

FIG. 7 is a block diagram of an example of an integrated data stream, under another alternative embodiment.

FIG. 8 is a block diagram of an example of an integrated data stream, under yet another alternative embodiment.

### DETAILED DESCRIPTION

Dynamically configurable streaming data systems and methods are described herein. The dynamically configurable systems and methods, collectively referred to herein as dynamically configurable streaming systems (DCSSs), include a dynamically configurable accelerator that reduces central processor load required to decompress, decode and decrypt data streams. The DCSS provides the capability to efficiently process (e.g. decompress, decode, decrypt, etc.) data streams compressed, encoded and encrypted by a variety of video compression algorithms. The data streams, also referred to as content streams, include A/V streams but are not so limited. The DCSS generally provides hardware acceleration that minimizes the processor requirement in the HDD by providing a system configuration that delivers within the currently received data stream only the elements needed for decoding the received data stream. The DCSS therefore provides a dynamically configurable and updateable system for processing streaming content or data.

The DCSS generally includes a hardware accelerator that shunts decoding operations away from a host system CPU to a dedicated decoder, thereby reducing the processing load on the host CPU. Furthermore, and in contrast to conventional dedicated decoders, this system provides a dynamically programmable decoder that is programmed or controlled by information of a received data stream. Components of the DCSS include a Core Executable and a Decoding Component, each of which are described below. The Core Executable Component is pre-loaded into the DCSS but is not so limited. The Decoding Component, in contrast to being pre-loaded, is received as a component of a data stream. In an embodiment the data stream that includes the Decoding Component is the same data stream used for transmitting the content.

A first portion of the received stream includes the decoding libraries or algorithms and a second portion of received stream includes A/V information or content. The decoding libraries are cached in the DCSS as they are received. The Core Executable subsequently uses information of the cached decoding libraries to decode content of the stream. In using the decoding libraries, the Core Executable uses information of the decoding libraries to dynamically initialize or configure the decoder on the fly to perform a particular type of decoding (e.g. Moving Picture Experts Group (MPEG), Windows Media Video (WMV), proprietary codec, etc.). The initialization can occur at the beginning of each received stream but is not so limited.

The term “computer” refers to any device capable of performing processing operations. Computers include devices capable of communicating over a data network and decoding for nearly simultaneous playback of an incoming data stream that is encoded with audio and/or video signals. Such a stream is referred to herein as a data stream. The audio and/or video signals, once decoded, may be played back on the computer or another device for reproducing the sound and/or video represented by the signals. A computer may further include or be associated with a visual display. In the embodiments described herein, a computer takes the form of a microprocessor-based personal computer, that includes a general purpose microprocessor, temporary program and data storage, such as random access memory (RAM), permanent program and data storage, such as a disk drive or read-only memory (ROM), a monitor or other visual display for displaying graphics, a sound card for decoding and converting digital signals to analog signals, and/or input/output systems like a keyboard and/or mouse for receiving inputs or data from a user. However, computers may also include limited function Internet appliances having limited display, data, data input, and user programming capabilities, such as personal organizers, telephones and other limited or special purpose devices.

The term “central server” or “server” refers to a single server or multiple interconnected servers or computers located at a central geographic area or in multiple geographic areas, including a load balancer that can be included within a multiple server configuration. The server also includes a computer and/or group or set of computers connected to a network and configured with applications or software to store and stream A/V content to remote devices.

The term “compression” or “encoding” refers to reducing the size of a data file or stream. The compressed stream can subsequently be transmitted over a packet network, for example. The compression or encoding can be embodiment in a compression or encoding algorithm or application.

In the following description, numerous specific details are introduced to provide a thorough understanding of, and enabling description for, embodiments of the DCSS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

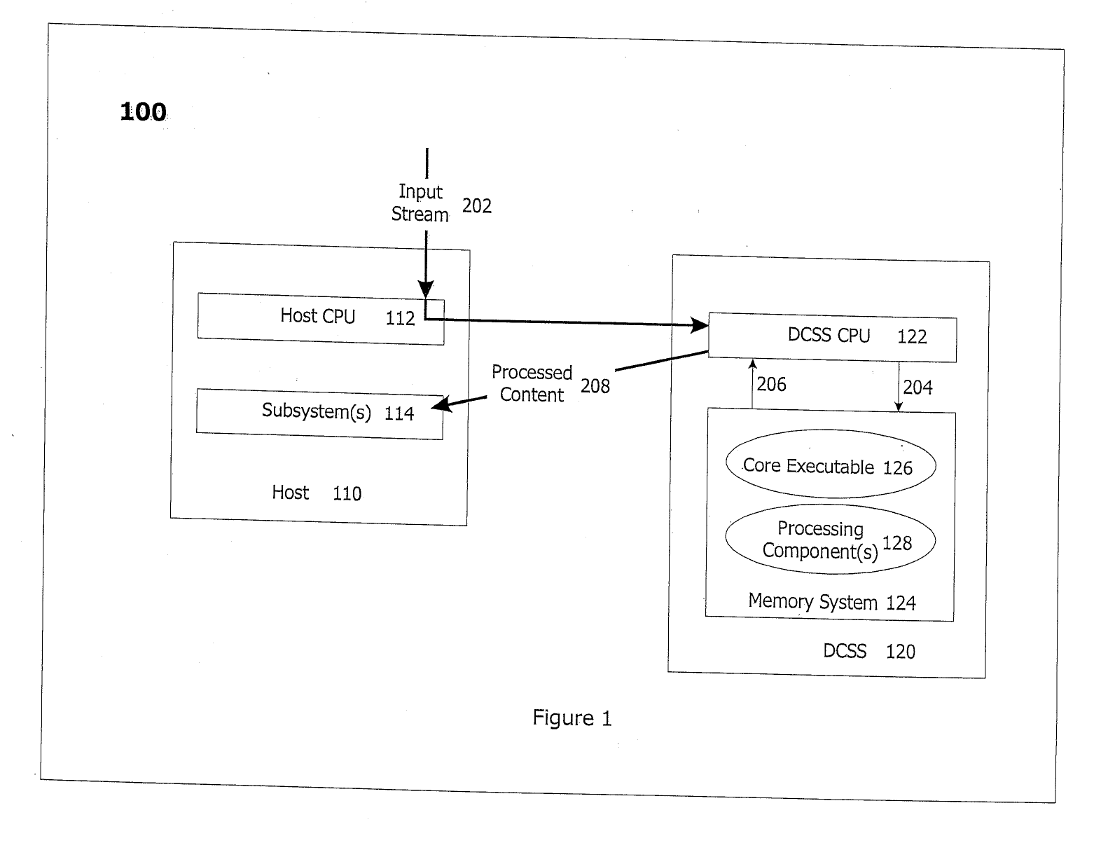

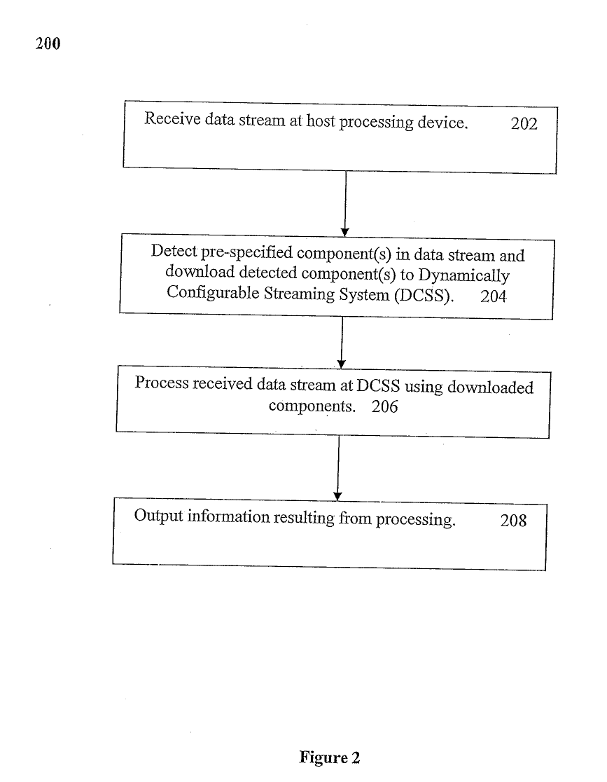

FIG. 1 is a block diagram of a processing system 100 including a dynamically configurable streaming system (DCSS) 120, under an embodiment. FIG. 2 is a flow diagram of dynamically configurable processing 200, under an embodiment. The processing system 100 comprises a host device 110 that includes a central processor 112 and some number of subsystems 114. The host device 110 is coupled to the DCSS 120 via one or more wired, wireless, or hybrid wired/wireless couplings of connections. The DCSS 120 can be a component of the host device 110 or alternatively in another remote or local component coupled to the host device 110. The DCSS 120 includes a central processor 122 and a memory system 124. The DCSS 120 includes a Core Executable component 126 that runs under the DCSS central processor 122; the Core Executable can be stored in the memory system 124 but is not so limited.

Each of the host device 110 and the DCSS 120 can include any number or type of other systems, subsystems, or components (not shown) as appropriate to the functions of the host device 110 and the DCSS 120. Examples of other systems, subsystems, or components include a graphics or display system, a processing system, memory devices like flash, RAM, and/or ROM devices, a monitor or other visual display for displaying graphics, a sound card for decoding and converting digital signals to analog signals, and/or input/output systems like a keyboard and/or mouse for receiving inputs or data from a user.

In operation, and with reference to FIG. 1 and FIG. 2, the processing system 100 receives 202 input data. The input data is received via data streaming or “streaming” but is not so limited. The term “streaming” refers to a process for transmitting audio, video, A/V and other types of continuous signals, which have been digitized, over packetized data networks such as the Internet for nearly contemporaneous playback. A signal is streamed by encoding the signal as a series of data packets and sending the data packets over a packet switched data network in a manner that supports contemporaneous or nearly contemporaneous playback on a viewing terminal using a player application or embedded software in the device. Presently, there are several streaming standards and approaches, including those used by the RealPlayer® of RealNetworks, Inc, the Windows Media Player® of Microsoft Corporation, and the QuickTime® player of Apple Computer, Inc., for encoding and controlling the stream. Prerecorded content, such as sound recordings and video tapes, and “live” content, such as retransmission of radio and television broadcasts, are presently being transmitted over the Internet using streaming. Graphical advertisements are also transmitted for displaying on a computer or viewing terminal screen in connection with the playing of the media stream. In addition, audio, video or other streaming media advertisements are sometimes transmitted prior to transmission of the content.

The data stream can be transmitted over a packet network such as the Internet by a streaming server or other device to transmit data and video images. A packet network generally includes one or more interconnected public and/or private networks that route packets or frames of data, as opposed to circuit switched networks and television or radio broadcast networks. A packet network includes the system of interconnected computer networks known as the Internet that route data packets using the Internet Protocol (IP) as it exists presently now or in future versions or releases.

The Core Executable component 126 detects and identifies 204 processing components 128 of the data stream, downloads the processing components 128, and stores the downloaded processing components 128 in the memory system 124. The processing components 128 include the Decoding Component of the DCSS but are not so limited. The Core Executable 126 subsequently or simultaneously uses the processing components 128 to process 206 data or “content” of the data stream. The term “content” refers to data including any form of visual or audio information such as but not limited to entertainment, telemetry, monitoring, navigation or surveillance. The content can be provided by a computer or an embedded application operating on a dedicated device which relays digital content collected by a digital or analog input device such as a video camera, microphone, transponder, global positioning system (GPS), unit, etc. and formatted by means of an appropriate digital converter to the central server system. The processed content is transferred 208 to the host device 110 under control of the DCSS 120 for use by one or more subsystems 114 of the host device.

The concepts of the DCSS can be applied to other systems and functionality of a processor-based device. For example, conventional processor-based systems include drivers that are necessary for operations of various subsystems of the host device, the subsystems including for example, video systems, sound systems, memory systems, USB systems, hard drive controllers, power management, Ethernet and network systems and printer systems to name a few. The DCSS, in contrast to the use of drivers, allows for loading a current version of code into a subsystem processor or chipset as appropriate to operations of the processor, instead of installing a driver at the time the chipset is installed in the host device. This allows a PC or computing system for example to be configured as a generic device that includes a number or array of universal processors which may or may not be geographically disbursed into a system configuration that is dynamically configured via the decoding algorithms or other configuration information transmitted as or as a component of a received data stream.

As another example, a display subsystem can be dynamically configured, using the DCSS, via a configuration algorithm received in a data stream along with content to be displayed on the configured host system. The manufacturer of the display subsystem then provides or sells, instead of processors, configuration algorithms or code that are sent via a data stream to a processor-based device hosting a processor subsystem dedicated for display tasks. The configuration algorithm when executed initializes one or more of the universal system processors and thus configures the set of universal processors as a display subsystem to display electronic media according to the manufacturer specifications.

An example system that includes the DCSS is a network broadcast streaming system that provides streaming or transmission of one or more of video, audio, and A/V data or signals as the data stream or content stream. A remote data terminal or client computer can function as a device for a user to enjoy the streaming broadcast. The data terminals or client computers, which include the DCSS described herein, can be coupled or connected to a packet network directly or indirectly, such as through a dial up connection, a wireless gateway, a cable modem, a DSL-type modem, or local area network. The data stream to one or more data terminals can be transmitted over a packet network such as the Internet by a streaming server or other device configured to transmit data and video images. Although only one client computer or terminal is described for purposes of explanation, the same media stream may be transmitted to a large number of client computers or the server may be transmitting media streams with differing content to different computers.

The streaming broadcast server can receive content signals from a source or central data server capable of linking viewers to digitized video files, audio files and other content across the packet network. The signal source may be supplied to the central data server from a terrestrial radio station or television station, or other service that provides audio and/or video programming content. For example, one or more digitized live broadcasts may be directed to central data server. The system provided in accordance with this embodiment can be used to transmit live radio (audio) and/or video broadcasts. Streaming encoders digitize, and if desirable, format and encode these signals as a data stream that can be directed to the central data server for transmission across the packet-based network. Moreover, a library of digitized video files contained within a storage system may be accessed by the central data server for transmission or video streaming to remote data terminals. Any type of data transport mechanism can be used to transmit the content signal in the system, including those that transmit the signal in a digital format. Other processes can handle the transport of the media stream over the coupling or connection of the streaming server to the packet network.

An embodiment streams live content in real time (audio and/or video signal) from a content source accessible to the central data server and/or streaming broadcast server. When the source of the content signal is a broadcast radio station or television network, the signal that is broadcast can also be provided in real time for immediate streaming. Once the signal arrives, an audio automation system can immediately connect it to a streaming encoder in order to prepare a data stream in suitable format for transmission across the packet network to remote terminals.

The streaming network broadcast system can incorporate advertising into the data stream to users. This provides an opportunity for generating revenue similar to present forms of Internet advertising. The advertising content may be updated and stored in a database connected to the central data server. At the same time, a database containing advertising fee account information can be coupled to the central data server to track and calculate the revenue to be collected according the how many or how often selected advertising is injected into content data streams.

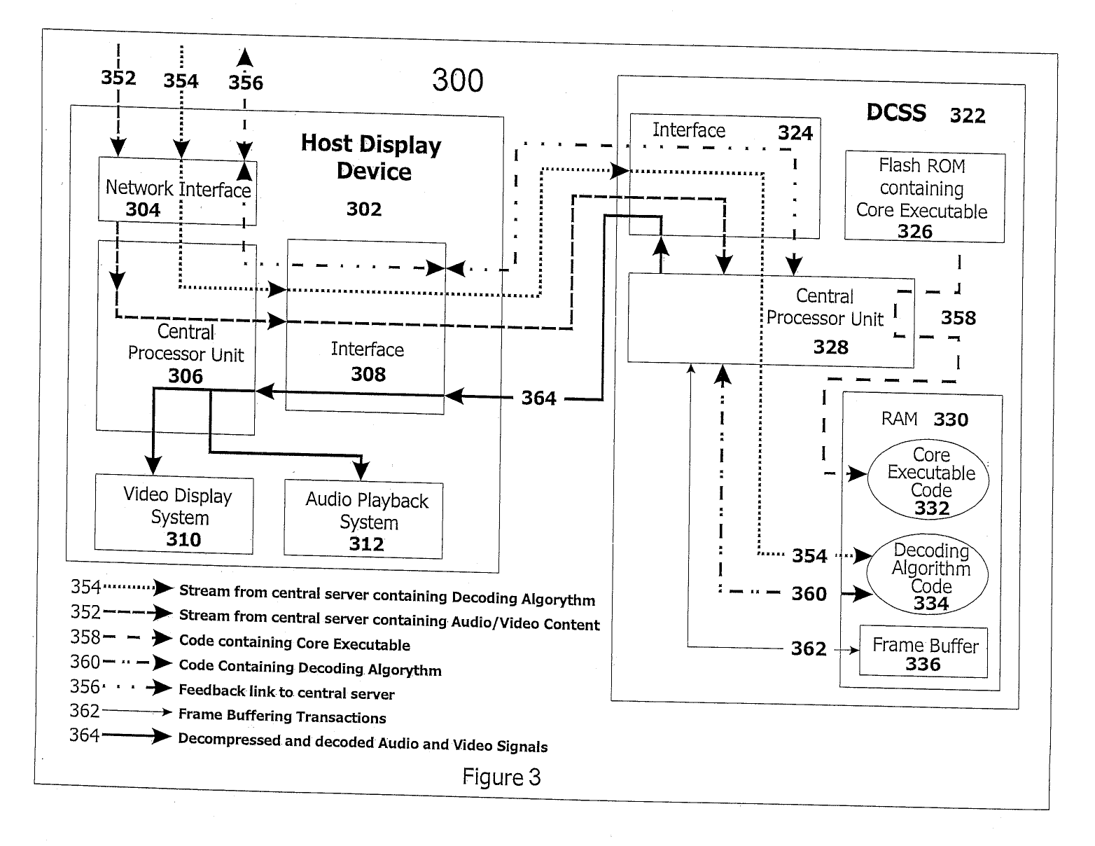

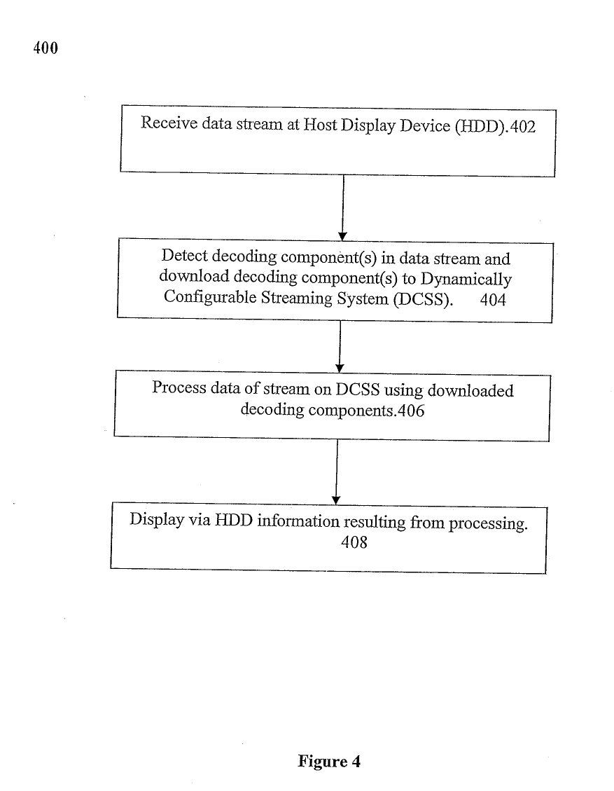

As a more specific example of a remote data terminal or client device configured to receive one or more of video, audio, and A/V signals as the data stream or content stream, FIG. 3 is a block diagram of a processing system 300 including a dynamically configurable streaming system (DCSS) 322, under an embodiment. FIG. 4 is a flow diagram of dynamically configurable processing 400, under an embodiment. The processing system 300 comprises a Host Display Device (HDD) 302 coupled to a DCSS 322 hosted on a microchip or IC device, but is not so limited. The DCSS 322 can be a component of the HDD 302; alternatively, the DCSS 322 can be located in another remote or local component coupled to the HDD 302.

The HDD 302 is a processor-based device configured to process data including streaming data. The processing of streaming data includes but is not limited to receiving, decompressing, decoding, decrypting, playing, and/or displaying of data that includes A/V data. The HDD 302 includes one or more of network couplings or connections, a central processor unit (CPU), memory, I/O functions, video systems or subsystems, audio systems or subsystems. The HDD 302 is configured to and capable of executing applications residing on one or more memory devices, internal hard drives, flash memory devices, and/or removable media such as Secure Digital Input/Output (SDIO) cards and or microchips. The HDD 302 includes but is not limited to processor-based devices like computers, portable computers (PCs), handheld computers, personal digital assistants (PDAs), set-top boxes (e.g. television), and/or other devices.

The HDD 302 includes a network interface 304 coupled to a HDD CPU 306. The HDD CPU 306 is coupled to a DCSS interface 308 and systems or subsystems that include a video display system 310 and an audio playback system 312 to name a few. The network interface 304 functions to couple the HDD 302 with one or more network or central servers (not shown). Alternatively, the network interface 304 provides for couplings between the HDD and any type of electronic device or system. The data stream is received via the network interface 304.

The DCSS interface 308 couples the HDD 302 to the DCSS 322 via an HDD interface 324 of the DCSS 322 and one or more wired, wireless, or hybrid wired/wireless couplings of connections. The HDD interface 324 is coupled to the DCSS CPU 328. The DCSS CPU 328 is also coupled to a non-volatile memory like ROM device 326 (e.g. flash ROM) and a volatile memory device 330 (e.g. RAM).

The DCSS 322 of an embodiment includes a Core Executable component and a Decoding Component, each of which are described below. The Core Executable Component is pre-loaded into a component of a DCSS 322 as described elsewhere herein. The Decoding Component, in contrast to being pre-loaded on the DCSS 322, is received as a component of a data stream. In an embodiment the data stream that includes the Decoding Component is the same data stream used for transmitting the content. Alternative embodiments can transmit the Decoding Component in a stream separate from that transmitting the content.

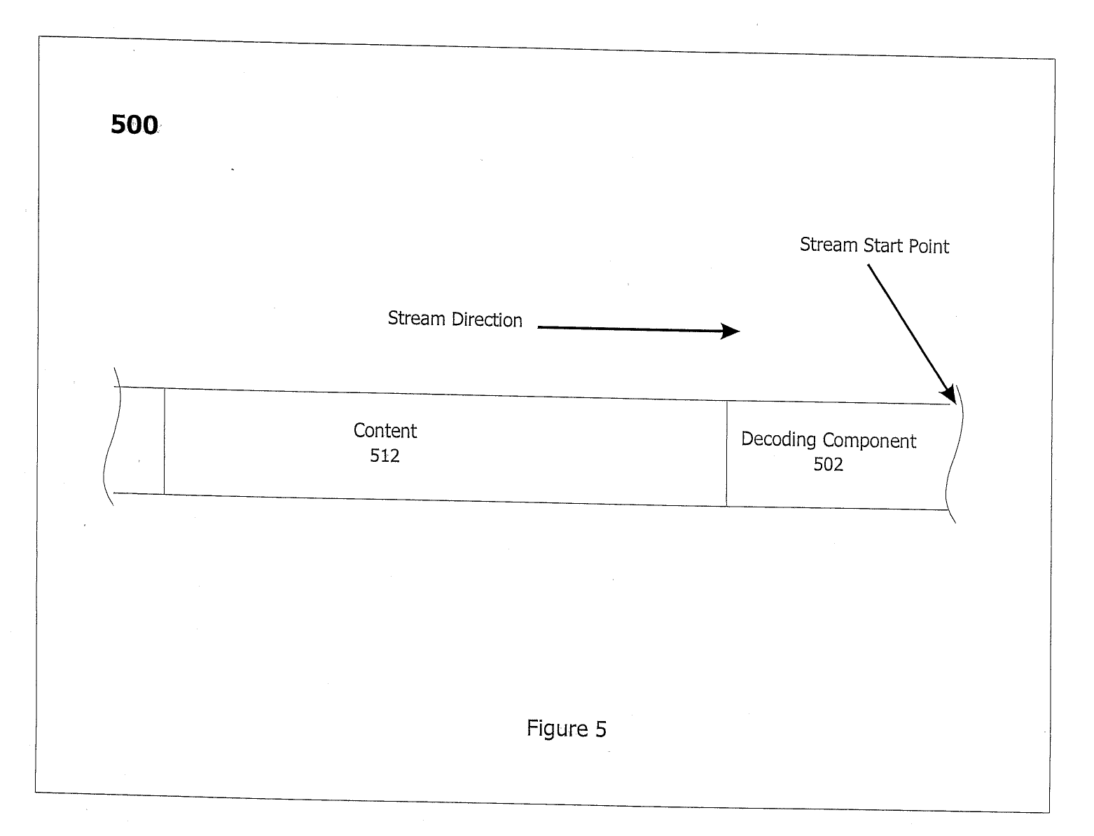

When the Decoding Component is transmitted in an integrated stream, for example, the stream includes a compressed, encoded and encrypted A/V stream received from a central server along with the Decoding Component. The Decoding Component includes information of the compression and/or encoding algorithms needed to decompress, decode and decrypt the data stream into a recognizable signal capable of output or presentation on the HDD. FIG. 5 is a block diagram of an example of an integrated data stream 500, under an embodiment. The stream 500 is configured to include a Decoding Component 502 followed by the data content 512.

The DCSS of an embodiment allows system configurations that include multiple Decoding Components within a single HDD, thereby allowing simultaneous display of multiple independent content streams and/or multiple independent content segments of an integrated stream. Each of the content segments and/or streams can be compressed, encoded and encrypted by the same or different compression and or encoding algorithms to be simultaneously displayed on the same or different screens by the HDD. The DCSS supports the simultaneous use of multiple Decoding Components by receiving multiple Decoding Components in a received stream and storing each of the Decoding Components in a different area of the volatile memory of the DCSS. The stream therefore can include a variety of configurations of one or more Decoding Components along with one or more content streams, some examples of which follow.

As an example, the content stream includes multiple content segments that each includes content formatted using one or more encoders or formats that deliver many types of content having different encoding formats. An example is a stream that includes a selected program in a first format (e.g. proprietary format) and one or more commercials in a second format (e.g. MPEG). The commercials can be placed in various portions of the integrated content stream. The DCSS system is dynamically re-programmed as appropriate to the streaming media to decode and play all material of the A/V stream as it is presented in the A/V stream. The additional content can be, for example, a batch file.

The received stream therefore also includes multiple decoding libraries that are each received in the first portion of the stream and stored in the volatile memory. The DCSS then uses the decoding libraries to re-program the decoder on the fly as appropriate to decode various content of the A/V stream.

Therefore, the DCSS is generally a universal video decoder and the integrated stream is a batch stream that includes multiple decoder libraries downloaded and/or accessed as appropriate to the content of the stream. As an example, an integrated stream can include content in both MPEG and proprietary formats. Assume for purposes of this example that the programming of the integrated stream includes a first commercial that leads the feature presentation and a second commercial that follows the feature presentation. The first and second commercials are each in the MPEG format while the feature presentation is in the proprietary format. The integrated stream of an embodiment is configured to include an MPEG decoder in a first portion of the stream. The MPEG decoder is downloaded and cached, and subsequently used to begin processing and playing the first commercial. During the presentation of the first commercial, the DCSS receives and downloads and pre-caches the proprietary decoder. Following the presentation of the first commercial, the pre-cached proprietary decoder is used by the core executable to configure the CPU to decode and present the feature presentation. Upon completion of the feature presentation, the core executable dynamically re-configures the CPU for presentation of the second commercial using previously cached MPEG decoder.

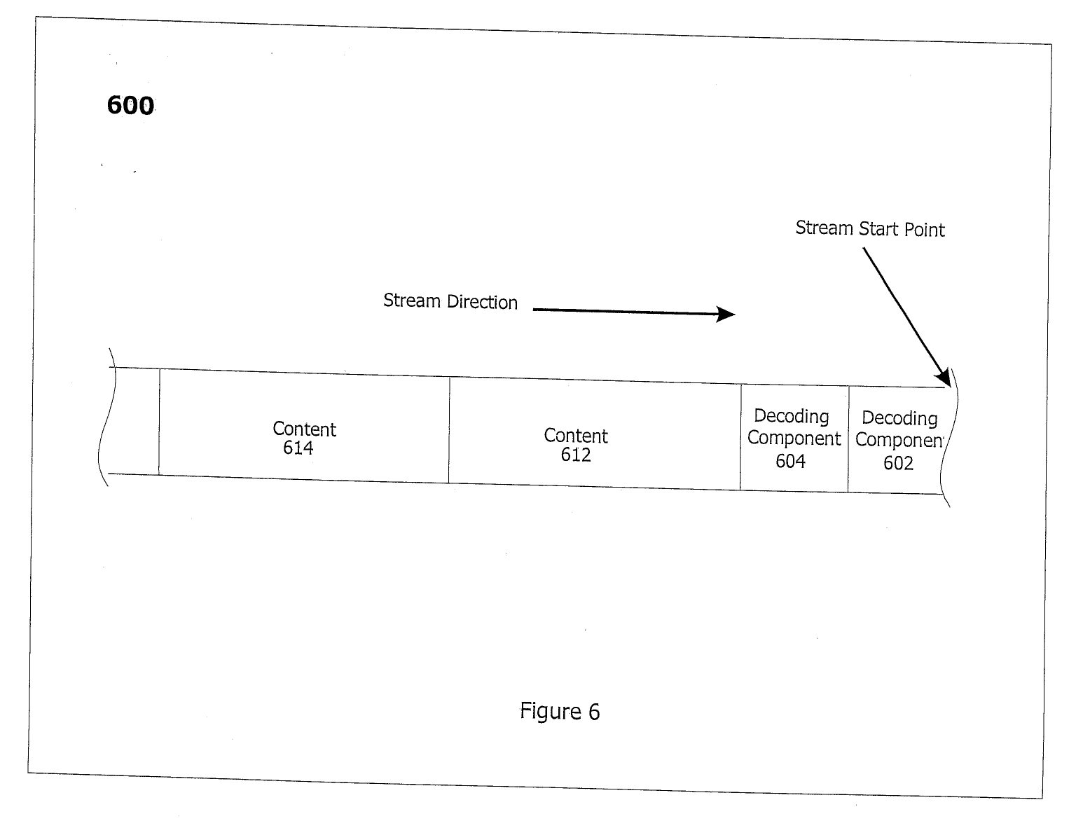

As further examples of integrated streams, FIG. 6 is a block diagram of an example of an integrated data stream 600, under an alternative embodiment. The stream 600 is configured to include a first Decoding Component 602 and a second Decoding Component 604 followed by first data content 612 and second data content 614. The first Decoding Component 602 is subsequently used by the HDD to process first data content 612, and the second Decoding Component 604 is subsequently used by the HDD to process second data content 614, but the embodiment is not so limited.

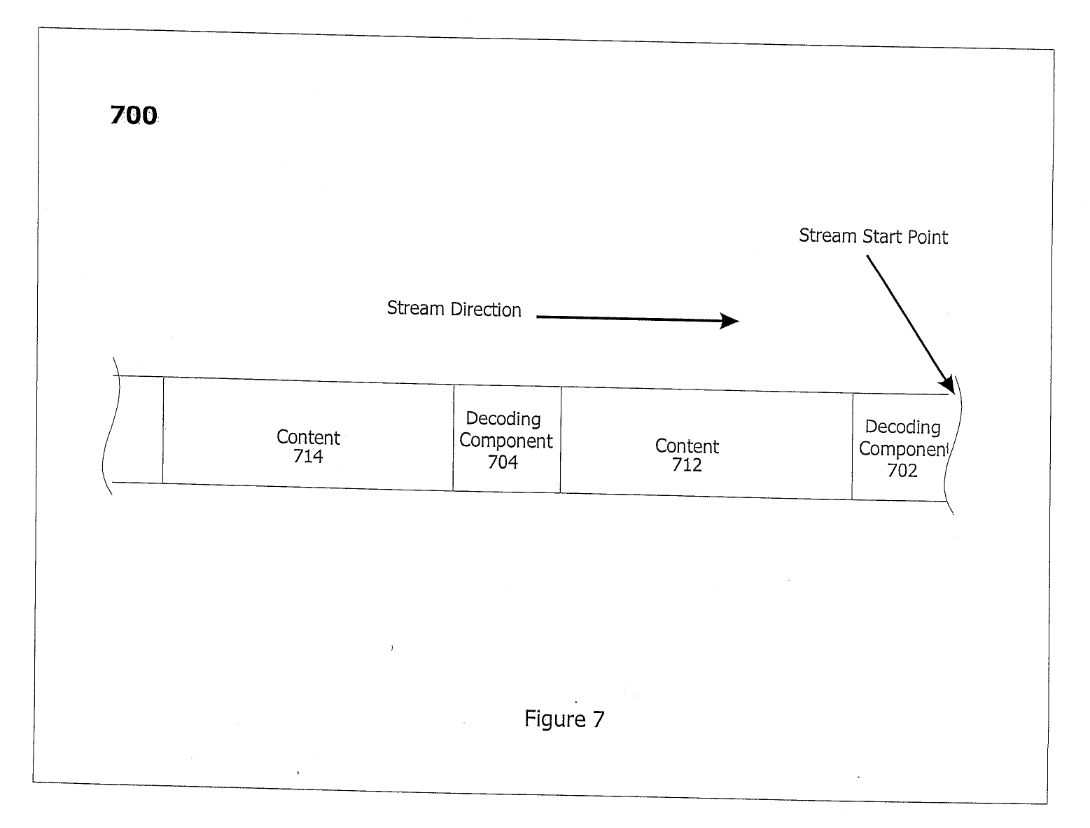

FIG. 7 is a block diagram of an example of an integrated data stream 700, under another alternative embodiment. The stream 700 is configured to include a first Decoding Component 702 followed by first data content 712. The stream 700 also includes a second Decoding Component 704 followed by second data content 714. The first Decoding Component 702 is subsequently used by the HDD to process first data content 712, and the second Decoding Component 704 is subsequently used by the HDD to process second data content 714.

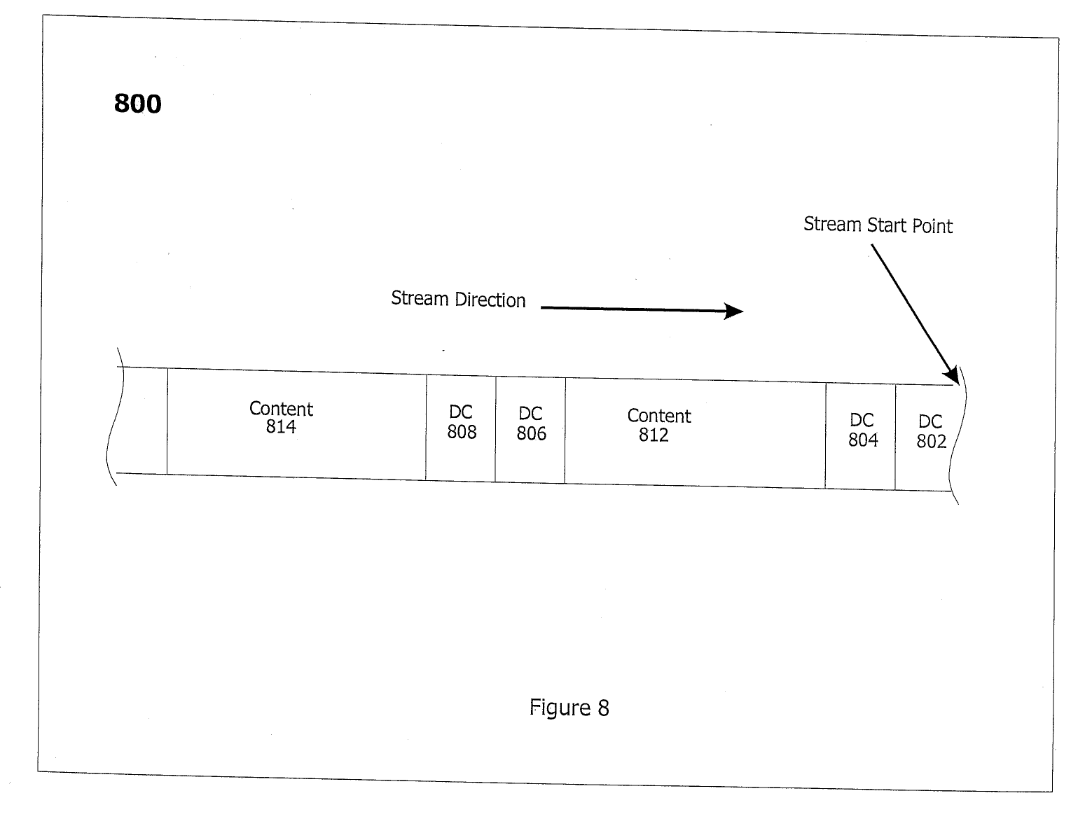

FIG. 8 is a block diagram of an example of an integrated data stream 800, under yet another alternative embodiment. The stream 800 is configured to include a first Decoding Component 802, a second Decoding Component 804, and first data content 812 in succession. The stream 800 also includes a third Decoding Component 806, a fourth Decoding Component 808, and second data content 814 in succession. The first Decoding Component 802 is subsequently used by the HDD to process first data content 812, and the second Decoding Component 804 is subsequently used by the HDD to process second data content 814. While these examples of integrated data streams 500-800 are presented herein, the embodiments are not limited to these examples.

The Core Executable interacts with the Decoding Component to process information of a received data stream. The DCSS 322 includes a Core Executable component stored in the non-volatile memory 326. The Core Executable is pre-loaded on the DCSS and runs under the DCSS CPU 328 but is not so limited. The Core Executable detects the Decoding Component within a compressed, encoded and encrypted video stream and stores it in the volatile memory 330 of the DCSS. The Core Executable executes the commands, instructions, and/or libraries included within the Decoding Component 334 according to any additional parameters included within the Decoding Component 334. The Core Executable is also configured to manage tasks such as routing the compressed, encoded and encrypted A/V signal received from the central server through the HDD. The Core Executable also manages other functions such as IO functions, frame buffering, packet scheduling, memory management, video output, interfacing with local variables in order to validate user authentication etc.

The Core Executable of an alternative embodiment is stored on the HDD as a program embedded into a removable microchip such as a compact flash, Universal Serial Bus (USB), and/or SDIO card which can be easily connected and disconnected to any one of several types of HDDs. The Core Executable of another alternative embodiment is stored as a program embedded in a microchip or other IC device of the HDD. In yet another alternative embodiment, the Core Executable is a stored on a hard drive of the HDD.

The Decoding Component is also referred to as the Video Player Software (VPS). The VPS refers to an application or software program configured to receive, decompress and display streaming data on a processor-based device like a computer, portable computer (PC), handheld computer, personal digital assistant (PDA), set-top box (e.g. television), and/or other device. The streaming data of an embodiment includes A/V content for example, but is not so limited. The Decoding Component, also referred to as a Decoding Algorithm, includes an array of function libraries including one or more of operating instructions, mathematical formulas, code instructions and other information needed to decompress, decode and decrypt the received data stream. The received data stream includes a compressed, encoded and encrypted A/V stream received from a central server, and the Decoding Component includes information of the compression and/or encoding algorithms needed to decompress, decode and decrypt the data stream into a recognizable A/V signal capable of display on the HDD. The Decoding Component of an embodiment is integrated or included in the data stream transmitted to the HDD from the central server along with the A/V content but is not so limited. The Decoding Component can also include data of other operating parameters that identify various aspects of the display such as size, frame rate, frame buffer size, etc.

The DCSS operation of an embodiment, with reference to FIG. 4, generally receives 402 a data stream at the HDD and routes the received stream to the DCSS. Decoding components in the data stream are detected and downloaded 404 by the DCSS. The decoding components, once downloaded, are used by the DCSS to process 406 content of the data stream. The processed content is transferred to the HDD for display 408 by components or systems of the HDD.

More specifically, as described above, the DCSS is hosted on a processor-based device. Using the processing system 300 described above with reference to FIG. 3 the DCSS is hosted on a DCSS chip 322 but is not so limited. In operation, and with reference to the dynamically configurable processing 400 of FIG. 4, the Core Executable is executed and loaded into memory 332 of the DCSS chip 322 from the non-volatile memory 326 of the DCSS chip. The DCSS 322 executes the Core Executable 332 and initiates a video streaming session from a central server (not shown). The video streaming session includes transmission of a stream to the HDD that includes the Decoding Component 354 and the content 352.

The compressed, encoded and encrypted A/V stream 352/354 from the central server is received by the HDD and transferred to the DCSS through the HDD interface 324 under control of the DCSS CPU 328. The Core Executable 332 operating on the DCSS detects the Decoding Component 354 and stores it in a memory area 332 of volatile memory 330 of the DCSS. The Core Executable 332 also creates variable frame buffers within the volatile memory 330, sends any appropriate display parameters such as display size to the HDD 302 via the HDD interface 324 and the DCSS interface 308, and provides any necessary feedback signaling 360 to the central server.

The Core Executable 332 processes the incoming compressed, encoded and encrypted content 352 received via the HDD according to the instructions and parameters of the Decoding Component 334 stored in the volatile memory 330. The Core Executable 332 also continually monitors content stored within the variable frame buffers within the volatile memory 330 as well as transmission rates, and adjusts the variable frame buffers to optimize performance and video quality.

The Core Executable 332 transfers the resulting processed content signal 364, which is the decompressed, decoded and decrypted A/V signal, back to systems of the HDD 302 via the HDD interface 324 and DCSS interface 308. A display system 310, audio playback system 312, and/or components of the HDD display the A/V.

The DCSS described herein provides hardware acceleration to minimize the processor requirement in the HDD while allowing for streaming of decoding elements for decoding the content in the stream along with the content. The DCSS thus provides a decoder that is dynamically configured or customized for each content stream (e.g. A/V stream) received without any user input and, in so doing, provides versatility in dealing with conventional as well as future A/V compression and encoding technologies.

Implementation of the DCSS on a microchip like the SDIO chip or card described above provides means to easily configure existing processor-based display devices (e.g. PDAs, PCs, handheld computers, etc.) equipped with an SDIO interface to an inexpensive portable HDD that can be used for viewing compressed and encoded A/V streams. The DCSS also supports the use of multiple decoders within a HDD to allow the simultaneous or near-simultaneous processing and display of multiple A/V streams compressed and encoded by one or more compression and/or encoding algorithms. Furthermore, the DCSS supports streaming of other information to the HDD, information that includes for example control algorithms to control or monitor such parameters as dropped frames and or transmission problems. These control algorithms can automatically adjust such aspects of the content as the frame buffer size and transmission rates to optimize performance; in addition the control algorithms can provide feedback signaling to the central server to adjust such parameters.

Embodiments of the dynamically configurable processing system of an embodiment include a method comprising receiving at a device a data stream that includes a processing component and data. The method of an embodiment includes detecting the processing component. The method of an embodiment includes configuring a subsystem of the device using the processing component. The method of an embodiment includes processing the data of the data stream with the subsystem following the configuring.

Aspects of the DCSS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the DCSS include: microcontrollers with memory (such as electronically erasable programmable read only memory (EEPROM)), embedded microprocessors, firmware, software, etc. Furthermore, aspects of the DCSS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the DCSS is not intended to be exhaustive or to limit the systems and methods to the precise forms disclosed. While specific embodiments of, and examples for, the DCSS are described herein for illustrative purposes, various equivalent modifications are possible within the scope of the systems and methods, as those skilled in the relevant art will recognize. The teachings of the DCSS provided herein can be applied to other systems and methods, not only for the systems and methods described above.

The elements and acts of the various embodiments described above can be combined to provide further embodiments. These and other changes can be made to the DCSS in light of the above detailed description.

In general, in the following claims, the terms used should not be construed to limit the DCSS to the specific embodiments disclosed in the specification and the claims, but should be construed to include all systems that operate under the claims. Accordingly, the DCSS is not limited by the disclosure, but instead the scope of the DCSS is to be determined entirely by the claims.

While certain aspects of the DCSS are presented below in certain claim forms, the inventor contemplates the various aspects of the DCSS in any number of claim forms. Accordingly, the inventor reserves the right to add additional claims after filing the application to pursue such additional claim forms for other aspects of the DCSS.

What is claimed is:

1. A method comprising:
receiving at a device a data stream that includes a processing component and data;
detecting the processing component;
configuring a subsystem of the device using the processing component; and
processing the data of the data stream with the subsystem following the configuring.
